(19) United States
(12) Patent Application Publication
(10) Pub. No.: US 2003/0177279 A1
(43) Pub. Date: Sep. 18, 2003

(54) Creation of middleware adapters from paradigms

(76) Inventor: James C. Evans, Maple Grove, MN (US)

Correspondence Address: Beck & Tysver, P.L.L.C., Suite 100, 2900 Thomas Avenue S., Minneapolis, MN, 55416, US

(21) Appl. No.: 10/359,815

(22) Filed: Feb. 6, 2003

Related U.S. Application Data
(60) Provisional application No. 60/355,213, filed on Feb. 8, 2002.
(60) Provisional application No. 60/367,139, filed on Mar. 22, 2002.

(51) Int. Cl. G06F 9/44; G06F 9/00

(52) U.S. Cl. 709/315; 709/328

(57) ABSTRACT

A method and software construct is presented for creating message-oriented middleware adapters utilizing predefined communication paradigms. The communication paradigm defines the communication between an initiator application and a respondent application during an overall exchange of data. The communication paradigm is then used to create an instance of an adapter core for either the initiator or the respondent application. The adapter core contains communication components that handle all communications in the paradigm. The present invention predefines a point-to-point paradigm and a publish-and-subscribe paradigm, and the adapters needed for these paradigms. Starting from these two basic paradigms, it is possible to create an infinite number of more complex paradigms, with each of these complex paradigms being formed from a combination of the basic paradigms or other previously defined paradigms. The present invention creates adapters for a newly defined paradigm by combining the adapters defined in the nested paradigms that make up the paradigm definition.

### CLAIM OF PRIORITY

This application claims priority to the following three provisional patent applications: U.S. Serial No. 60/355,213 filed Feb. 8, 2002; U.S. Serial No. 60/313,494 filed Feb. 12, 2002; and U.S. Serial No. 60/367,139 filed Mar. 22, 2002, and to U.S. application Ser. No. ______, entitled “Construction of Middleware Adapters,” which was filed on the same date as the present application, each of which are hereby incorporated by reference.

### FIELD OF THE INVENTION

This invention relates to the field of message-oriented middleware. More particularly, the present invention relates to the utilization of paradigms to automatically generate adapters that are used to connect one business application to another over a message-oriented middleware.

### BACKGROUND OF THE INVENTION

In order to meet the computing needs of a typical enterprise, it is necessary to operate numerous distinct computing platforms simultaneously. Spread over these various platforms, separate business software applications together handle the data processing needs of the enterprise. For example, in a retail company, separate business applications may handle merchandising, supply chain, and order management. Although these business applications and computer platforms are not generally designed to communicate with one another, it has long been recognized that some inter-program communication is required for an efficiently operating computing environment.

One class of software that allows such communication is known as message-oriented middleware. This type of middleware allows messages to be sent between a sending and a receiving business application program through the use of message queues. From a logical standpoint, the middleware uses a message transport layer to deliver messages over an underlying communications network layer. When a first business application wishes to communicate with a second business application, the first application composes a message and places this message in a message queue from which it is routed to a queue of the destination application. The message remains on the destination queue until it is received by the destination program, thereby providing asynchronous communication between the two applications. The message transport layer provided by the message-oriented middleware handles all aspects of queue maintenance and message delivery. As a result, it is not necessary to build this capability into each of the business application programs that communicate with each other.

It is necessary, however, to make sure that each business application is able to send and receive messages through the message transport layer. Generally, this is accomplished, at least in part, by using the business program's application program interface (or API), or, alternatively, via a data file that is written to and read by the application. The API specifies how data is sent into and out of the business application. One business application's API will be significantly different than that of another business application, and will typically differ significantly from the message and data structure that is expected by the message transport layer of the message-oriented middleware. Similarly, for applications that communicate through a data file, the data that is read from and written to the file is in a data format unique to that application. Thus the data must be transformed from one data format to another, which can occur at the adapter level or at a broker that forms part of the message-oriented middleware application. Hence, it is almost always necessary to create one or more adapters that convert the data and communication protocols specified by the business application's API or its external data file into the data messages handled by the middleware.

In some environments, a single business application may require numerous adapters, since that application may wish to communicate with numerous other applications in an enterprise. In addition, a separate adapter may be required to handle communications about each separate data topic that a business application may discuss with another business application.

Unfortunately, it is often a difficult and tedious task to develop these numerous adapters. Middleware developers and other third parties have created adapters for major corporate applications from vendors such as Peoplesoft, Oracle, and SAP. However, these prepackaged adapters often require customization to reflect the end user's actual computer environment. Furthermore, these prepackaged adapters will not work with customized versions of these applications, nor will they work with applications developed by the end users.

To meet the need for such customized adapters, companies have developed adapter toolkits, such as the MQSeries Adapter Builder tool from IBM (Armonk, N.Y.). Using this type of toolkit, an end user can map the data received from a business application's API into the desired message structure and vice versa. The toolkits simplify basic data manipulation such as padding, truncation, alignment, and allow for customized code to be generated for the adapter as needed. The toolkit also allows the developer to specify the sequence of calls to the business application that are necessary to process data found within incoming messages. Once these things are specified, the toolkit will generate the code for the actual adapter.

While these toolkits work well in creating application specific data translations and instructions for handling incoming data, they do not work well in the creation of adapters that handle complex middleware communication paradigms. For instance, most toolkits and predefined adapters are designed to handle a point-to-point communication. In this paradigm 10, as seen in FIG. 1, one business application acts as a sender 12 of a message 14. This message 14 is sent to the message transport layer 16 through a sender adapter 15, with a request that the message 14 be sent to the incoming queue of a receiver business application 18. The transport layer 16 maintains this queue for the receiver application 18, which later will retrieve the message 14 from its queue through a receiver adapter 17. Since the message 14 is sent from a single application 12 to another 18, this is considered a point-to-point communication.

In addition, some toolkits and predefined adapters are capable of handling a publish-and-subscribe communication, which is shown in FIG. 2. In this paradigm 20, a publisher business application 22 has data 24 that is desired by one or more subscriber business applications 26. Without a publish-and-subscribe paradigm 20, publisher application 22 would be required maintain a list of the subscribers 26 that desire its data 24, and then would be required to separately send the data 24 to each application 26 via the point-to-point paradigm 10 whenever the data 24 is available. The publish-and-subscribe paradigm 20 avoids this situation by requiring the subscriber applications 26 to subscribe to a particular topic 28 maintained by a broker running on the message transport layer 30. The publisher application 22 informs the broker whenever data 24 for that topic 28 is available or updated via its publisher adapter 23. The broker then notifies one or more the subscribing applications 26 through their subscriber adapters 25 that the data 24 is available. This notification can either include the requested data 24, or can inform the subscriber 26 that it can retrieve the data 24 from a known location, such as directly from the publisher application 22. If only notice is provided, an additional communication must take place in which the subscriber application 26 actually obtains the data 24 from the publisher application 22.

Many communications between business applications do not fall into the standard point-to-point or publish-and-subscribe paradigms. For instance, a request/reply communication requires one business application to request information from another. When the other business application receives the request, it replies with the requested data. In this type of paradigm, each application operates as both a sender and a receiver. Still further business requirements may require paradigms in which an acknowledgement is sent once a data message is retrieved, such as a request/reply with acknowledgement paradigm. Unfortunately, prior art adapter toolkits make these types of complex paradigms difficult to implement, often requiring separate adapters to handle each portion of the communication, even though only a single communication event occurs. What is needed is a system that can easily handle these types of complex communication paradigms within a single adapter without requiring complex, custom programming each time the paradigm is encountered.

### SUMMARY OF THE INVENTION

The present invention overcomes the limitations in the prior art by defining communication paradigms that will be used in an enterprise for middleware communications. In the preferred embodiment, a paradigm is an objection-oriented class that can be instantiated and is capable of producing an adapter core that will implement the paradigm. Every communication paradigm will have two possible roles, namely an initiator and a respondent. When an adapter core is requested from a paradigm, the requester must identify whether the adapter will be the initiator or the respondent for the selected paradigm. The paradigm then creates the adapter core that will perform the selected role within that paradigm. The adapter core is not complete until it is augmented with specific information about how to communicate with an application and the data transformations needed to convert between data formats used by the application and a standard data format.

Another advantage of the present invention is that one or more paradigms can be nested inside of another paradigm, thereby allowing complex communication paradigms to be constructed through the combination of simpler paradigms. The present invention starts by predefining two basic communication paradigms, namely point-to-point communications 10 and publish-and-subscribe communications 20. When more complicated communication paradigms are created, these paradigms are built upon a combination of these two basic paradigms as well as any other previously defined paradigms. The present invention thereby takes advantage of the fact that most every paradigm can ultimately be implemented as a combination of the point-to-point and publish-and-subscribe paradigms 10, 20.

### BRIEF DESCRIPTION OF THE DRAWINGS

FIG. 1 shows a point-to-point communication over a message transport layer as is known in the prior art.

FIG. 2 shows a publish-and-subscribe communication over a message transport layer as is known in the prior art.

FIG. 3 shows an initiator and respondent adapter pair of the present invention implementing a request/reply communication paradigm over a message transport layer.

FIG. 4 shows an initiator and respondent adapter pair of the present invention implementing a request/reply/acknowledge communication paradigm over a message transport layer.

FIG. 5 shows an initiator and respondent adapter pair of the present invention implementing a publish-and-subscribe paradigm with an acknowledgement communication.

FIG. 6 is a schematic representation showing steps involved in the construction of an adapter using a paradigm according to the present invention.

FIG. 7 is a flow chart showing the method of the present invention.

FIG. 8 is a schematic drawing showing the elements of an adapter constructed according to the present invention.

### DETAILED DESCRIPTION OF THE INVENTION

Paradigms

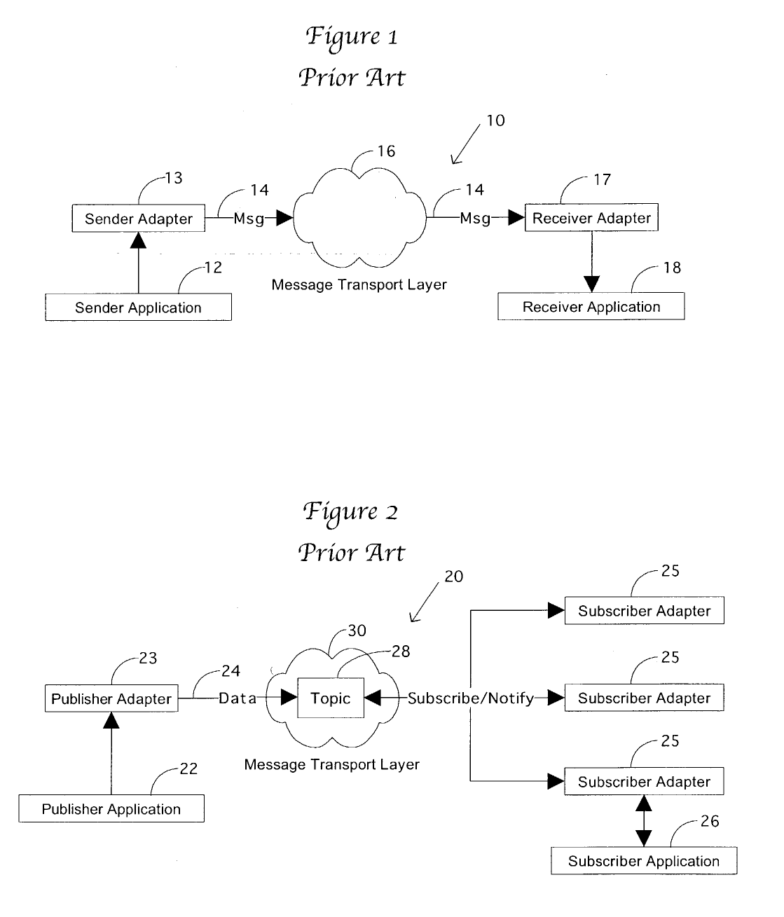

FIGS. 1 and 2 show communication paradigms 10, 20 that take advantage of message-oriented middleware technologies. In the context of the present invention, a paradigm is a communication scheme in which one or more separate communication elements are performed over a middleware application in order to complete a particular communication event. While a paradigm in the present invention can be considered the abstract definition of this communication event, the preferred embodiment implements paradigms in class definitions using an object oriented programming model, such as Java or C++. Hence, paradigms can be instantiated, and are capable of producing the adapters necessary to implement the communication event, as is described in more detail below.

For example, FIG. 1 shows a point-to-point paradigm 10 in which a sender business application 12 sends a single message 14 to a receiver business application 18. The communication between the sender business application 12 and the message transport layer 16 passes through the sender adapter 13, while the communication between the message transport layer 16 passes through the receiver adapter 17. The present invention definition of the point-to-point paradigm 10 would be an object-oriented class definition that defines this communication, and would include the logic necessary to create the primary components of the sender and receiver adapters 13, 17. This is described in more detail below. Similarly, FIG. 2 shows a publish-and-subscribe paradigm 20 utilizing publisher and subscriber adapters 23, 25. The publish-and-subscribe paradigm 20 in the present invention would therefore be an object-oriented class definition of this communication scheme which, when instantiated, would be able to automatically generate the primary components of the publisher and subscriber adapters 23, 25.

The actual functioning of the sender 13, receiver, 17, publisher 23, and subscriber 25 adapters created by these paradigms 10, 20 is not directly relevant to the understanding of the present invention. Prior art techniques for handling the sending and receiving of messages in point-to-point and publish-and-subscribe adapters 13, 17, 23, 25 are suitable for use in the present invention. Alternatively, the assignee of the present invention has developed a unique construction for middleware adapters which is set forth in U.S. application Ser. No. ______, entitled “Construction of Middleware Adapters,” which was filed on the same date as the present application. The construction of adapters set forth in that patent application can be used to perform the functions of the basic adapters 13, 17, 23, and 25 used by the present invention.

Furthermore, the arrows in FIG. 1 imply that sender business application 12 pushes the message to the sender adapter 13. However, this need not be the case, since it is well within scope of the present invention for the sender adapter 13 to pull the data message from the sender business application 12. The arrows between adapters and applications found in Figures are presented for simplicity in understanding the data communication in the present invention, and are not intended to limit which component initiates and controls the data interchange between an application and an adapter.

Complex Paradigms

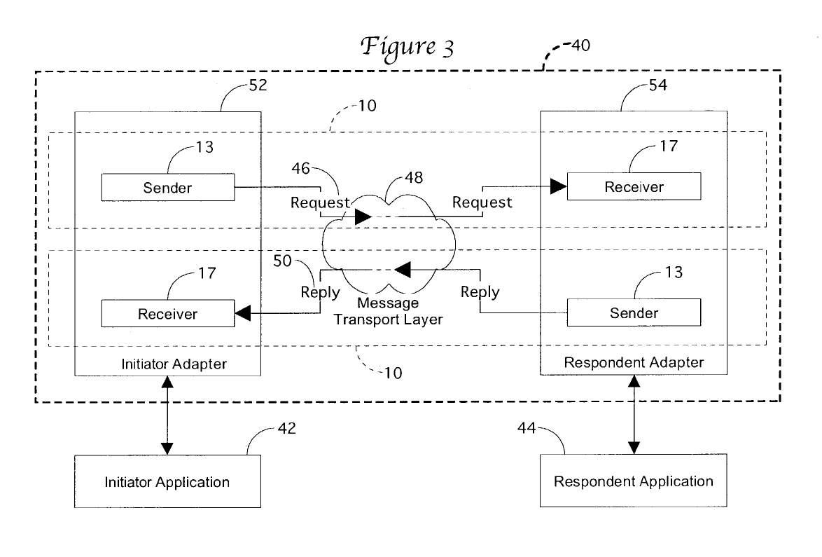

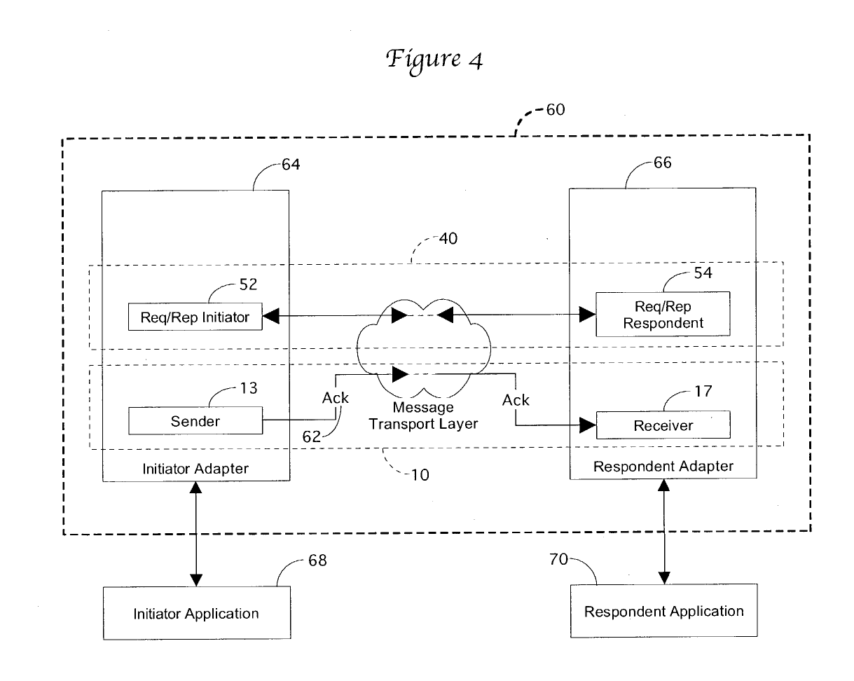

The present invention predefines the basic point-to-point paradigm 10 and the basic publish-and-subscribe paradigm 20. Starting from these two basic paradigms 10, 20, it is possible to create an infinite number of more complex paradigms, with each of these complex paradigms being formed from a combination of the basic paradigms 10, 20 or other previously defined paradigms. For example, FIG. 3 shows a request/reply paradigm 40 in which an initiator business application 42 requests information from a respondent business application 44. The initiator application 42 accomplishes this by sending a request 46 to the respondent application 44 through a message transport layer 48. When the respondent application 44 receives the request 46, it responds by sending the requested information in a reply 50 back to the initiator application 42 through the transport layer 48. The initiator application 42 communicates with the transport layer 48 through an initiator adapter 52, while the respondent application 44 communicates through a respondent adapter 54.

As shown in FIG. 3, these adapters 52, 54 handle both the request 46 and the reply 50 communications, which requires that each adapter 52, 54 be capable of both sending and receiving a communication through the message transport layer 48. This is accomplished by including both a sender component 13 and a receiver component 17 in each adapter 52, 54. In the initiator adapter 52, the sender component 13 sends the request 46 while the receiver component 17 receives the reply 50. Similarly, in the receiver adapter 54, the receiver component 17 receives the request 46 and the sender component 13 sends the reply 50.

The request 46 communication and the reply 50 communication each send a message from a sender 13 to a receiver 17 through the message transport layer 48. In this way, each of these communications can be considered a point-to-point communication like that shown in FIG. 1. Thus, the request/reply paradigm 40 is simply the combination of two point-to-point paradigms 10, the first communicating from the initiator application 42 to the respondent 44, and the second going in the opposite direction.

By defining the request/reply paradigm 40 as the combination of two point-to-point “sub-paradigms” 10, it is possible to construct the adapters 52, 54 of the request/reply paradigm 40 as a combination of the adapters 13, 17 found in these sub-paradigms 10. More specifically, the initiator adapter 52 is seen to be a combination of the sender adapter 13 of the first point-to-point sub-paradigm 10 with the receiver adapter 17 of the second point-to-point sub-paradigm 10. Similarly, the respondent adapter 54 of the request/reply paradigm 40 combines the receiver adapter 17 of the first point-to-point sub-paradigm 10 with the sender adapter 13 of the second point-to-point sub-paradigm 10. In this way, it is not necessary to define any of the basic communication elements in the initiator adapter 52 or the respondent adapter 54, since the subcomponent adapters 13, 17 that are generated by the sub-component paradigms 10 will handle all of these responsibilities. All that is left for the initiator and respondent adapters 52, 54 to accomplish is the coordination of communications between the application programs 42 and 44 and the subcomponents 13, 17. In addition, the present invention uses logic outside of the subcomponents 13,17 to handle security and logging for adapter 52, 54.

FIG. 4 shows a paradigm 60 where an acknowledgement 62 has been added to the request/reply paradigm 40 of FIG. 3. The acknowledgement 62 is sent from the initiator application 68 to the respondent application 70 to confirm that the reply 50 has been received. This acknowledgement 62 is simply another instance of a point-to-point paradigm 10 communication, meaning that this complex paradigm 60 can be considered the combination of a request/reply paradigm 40 and a point-to-point paradigm 10. Consequently, the initiator adapter 64 for this paradigm 60 is primarily composed of two subcomponents, namely, the initiator adapter 52 generated by the request/reply paradigm 40 and the sender adapter 13 generated by the point-to-point paradigm 10. Although the request/reply initiator adapter 52 is itself composed of a sender 13 and receiver 17 adapters as well as the logic necessary to coordinate these two adapters 13, 17, all of these details are handled within the subcomponent adapter 52. As a result, the initiator adapter 64 of the request/reply/acknowledge paradigm 60 does not need to be concerned with these details. Rather, as explained above, the initiator adapter 64 merely coordinates communication between its subcomponents 52, 13 and the initiator application 68 while also handling security and logging. Similarly, the respondent adapter 66 for this paradigm 60 is primarily composed of the respondent adapter 54 of the request/reply paradigm 40 and a receiver adapter 17 from the point-to-point paradigm 10.

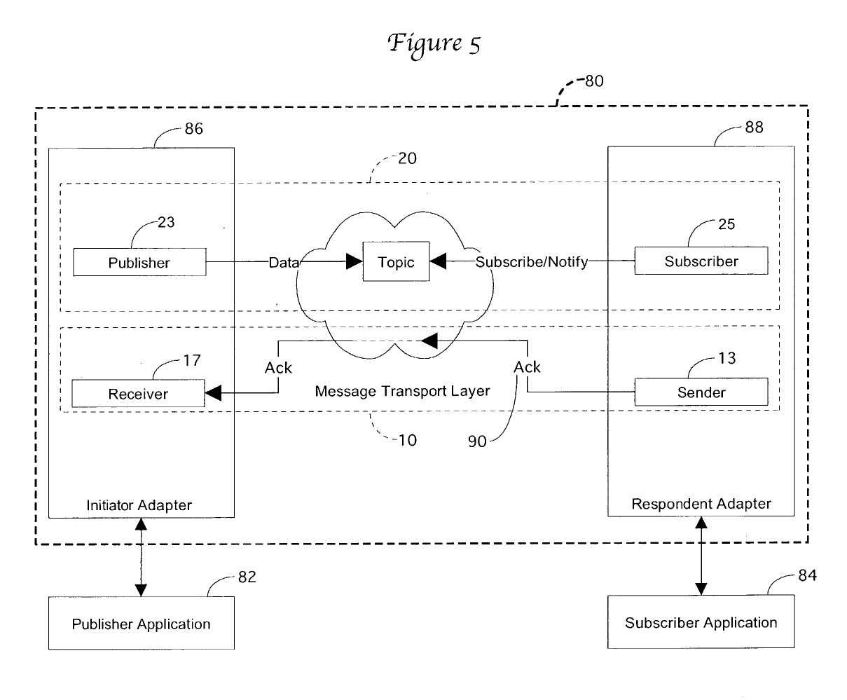

FIG. 5 shows a unique publish-and-subscribe paradigm 80 in which an acknowledgement 104 is communicated from a subscriber business application 84 to a publisher business application 82. As was the case in the publish-and-subscribe paradigm 20 shown in FIG. 2, multiple subscriber applications 84 are possible in this paradigm 80, although only a single subscriber application 84 is shown in FIG. 5. The primary difference between the paradigm 80 shown in FIG. 5 and the publish-and-subscribe paradigm 20 of FIG. 2 is the inclusion of an acknowledgement communication 90 being sent from the subscriber application 84 to the publisher application 82. This acknowledgement is yet another point-to-point communication 10, and the entire paradigm 80 of FIG. 5 can be conceptualized as an existing publish-and-subscribe paradigm 20 combined with a point-to-point paradigm 10. Consequently, the initiator adapter 86 of paradigm 80 is seen to be composed primarily of the publisher adapter 23 from the publish-and-subscribe paradigm 20 and the receiver adapter 17 from the point-to-point-paradigm 10. Similarly, the respondent adapter 88 contains the subscriber adapter 25 of the publish-and-subscribe paradigm 20 and the sender adapter 13 from the point-to-point-paradigm 10. Each adapter 86, 88 also includes the logic necessary to coordinate communication between its components and the application 82, 84 with which it interacts.

As can be seen in the above examples, it is possible to construct an endless variety of complex message oriented middleware communication paradigms simply by joining together different combinations of previously defined sub-paradigm. These sub-paradigms can either be one of the basic paradigms 10, 20 predefined by the present invention, or can themselves be a previously defined combination of other paradigms, such as those paradigms 40, 60, and 80 shown in FIGS. 3 through 5.

In each paradigm, there are at least two business applications in communication, an initiator business application that starts the communication process, and a respondent business application that communicates with the initiator. The primary purpose of defining these complex paradigms is to simplify the creation of the adapters for these two business applications. In effect, the definition of the paradigm allows the automatic creation of initiator and respondent adapters that have the necessary components to implement the paradigm, all based on a relatively few simple, reusable, easily maintainable, components. The definition of a paradigm can be based upon the nested combination of previously defined paradigms. This allows the adapters that are created by the paradigms to be easily constructed using a structure of nested, predefined adapters, with each adapter acting as the coordinator of each of its respective subcomponents.

Construction of an Adapter

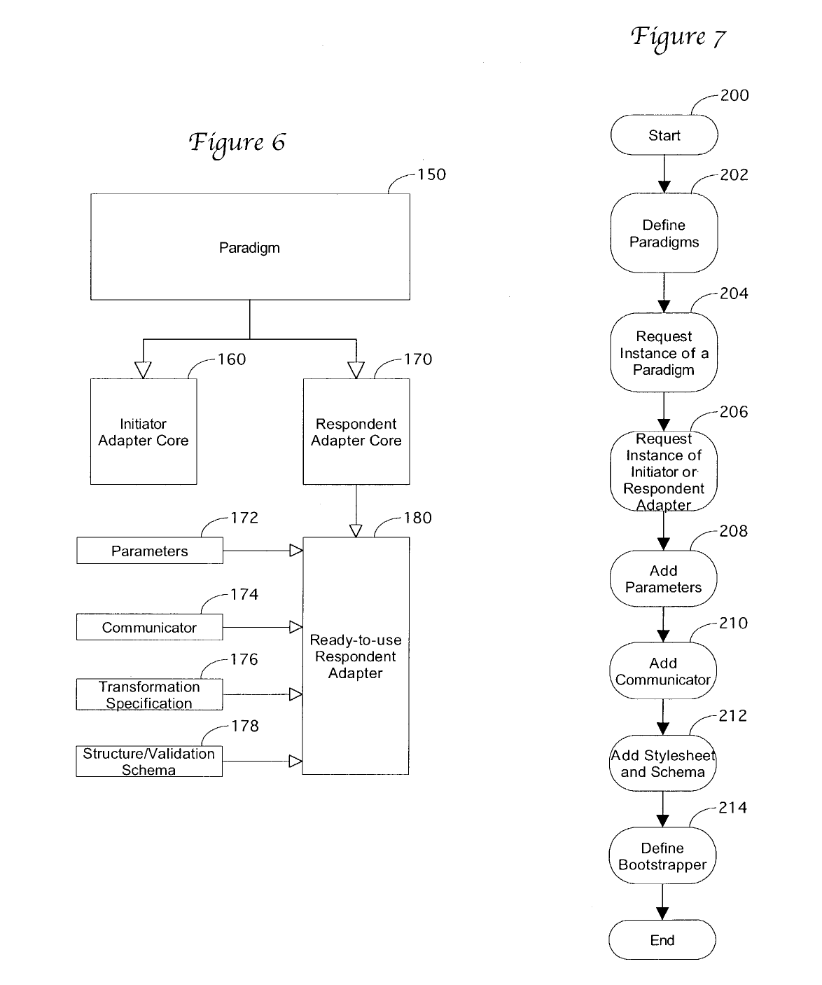

FIG. 6 shows a schematic representation of the construction of an adapter using the present invention. A paradigm 150 is first defined by combining one or more sub-paradigms, such as the point-to-point paradigm 10, the publish-and-subscribe paradigms 20, or a previously defined paradigm such as paradigms 40, 60, and 80 defined in FIGS. 3-5. Once the paradigm 150 is defined in a class and instantiated, the paradigm 150 is able to create an initiator adapter core 160 and a respondent adapter core 170. These adapter cores 160, 170 contain the programming to communicate with a message transport layer according to the communication scheme defined in the paradigm 150. This is easily done because the primary component of these cores 160, 170 are the adapters that are already defined in the sub-paradigms that make up the paradigm definition. In addition, the adapter cores 150, 170 will contain the logic needed to control the interaction between the sub-component adapters within the paradigm.

Of course, the adapters cores 160, 170 that are created by the paradigm 150 are not fully implemented until additional details 172-178 have been defined about the environment in which the adapter 160, 170 will operate. Once these details 172-178 are added to one of the adapter cores 160, 170, such as to the respondent adapter core 170 shown in FIG. 6, a ready-to-use adapter 180 is created.

The first details shown in FIG. 6 are the parameters 172 that define the context in which the adapter 180 will be used. In the preferred embodiment, a separate adapter 180 is created and used for each business application (i.e., an Oracle financials database), each location (i.e., a Trenton, N.J. retail store), and each data topic (i.e., a particular retail item) for which communication over the message transport layer is desired. These items are specified and defined by the parameters 172. Other parameters might include an adapter ID, and whether the messages handled by the adapter should be compressed or grouped. In a request/reply situation, the message would contain an identification for the information requested, such as customer credit information.

The communicator component 174 is responsible for interfacing directly with the business application program. Hence, all of the peculiarities of a particular business application are isolated to this communicator component 174, which allows the rest of the adapter 180 to be defined and programmed independently of the business application. In this way, only the communicator component 174 will require custom programming to conform the adapter 180 to the computer environment in which it will be used. It is also possible to reuse and subclass communicator components in an inventory of components that handle common situations (e.g., extract from an SQL data file or write a comma-separated values text file).

The transformation specification 176 is used to govern the data transformations between the data format expected by the business application program and the canonical data definitions that are defined by the enterprise. For instance, the transformation specification 176 could be an XSLT stylesheet for defining data transformations into canonical XML data definitions. Similarly, the structure/validation schema 178 (such as an XML schema) defines the structure and syntax for the data topic being communicated, such as the order and occurrence of elements, and the attributes for the data. These details 176, 178 are used to allow data transformation and schema validation within the adapter 180. By implementing such details in the adapter 180 rather than relying on the middleware product itself to do such tasks, the present invention follows the theory of implementing “fat” adapters. Alternatively, the broker of the middleware product could be relied upon to perform these types of data transformations. In this case, it would not be necessary to incorporate the transformation specification 176 and schema 178 into the adapter 180.

The preferred embodiment of present invention interfaces with middleware vendors primarily through Java Message Service (JMS) as opposed to one of the proprietary interfaces maintained by the vendors of message oriented middleware products. In addition to using JMS, the preferred embodiment is able to communicate via additional transports as well, such as FTP and HTML. To the extent interfaces to multiple transports are supported in the present invention, each of the four adapters 13, 17, 23, and 25 used in the two basic paradigms 10, 20 would have to have separate versions for each possible interface.

Adapter Creation Method

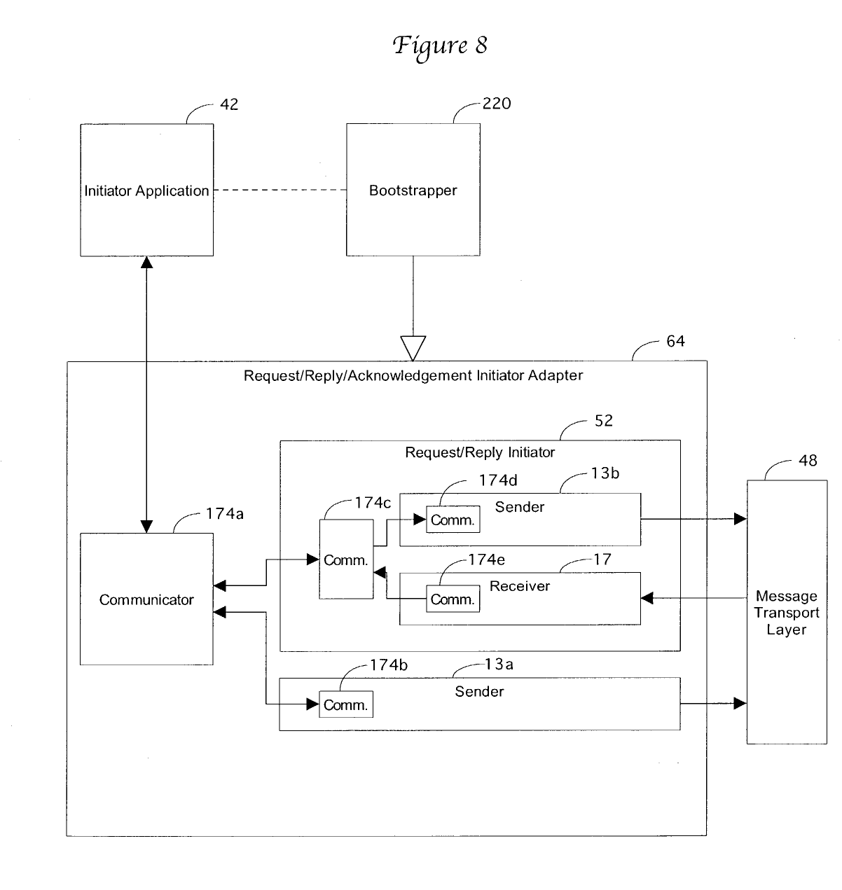

FIG. 7 shows a method 200 that can be used to create an adapter using the paradigms 150 of the present invention. The first step 202 of the present invention is to define the possible paradigms 150. This step may involve the use of nested paradigms 150, as is described above. Once the paradigms 150 are defined, an actor of some type requests an instance of a particular paradigm 150 in step 204. Generally, the actor will be a specialized software application designed to assist in the creation of a ready-to-use adapter 180.

In step 206, the actor then requests a new instance of an initiator or a respondent adapter core 160, 170 to be created by the paradigm 150. Once the core 160, 170 is created, the parameters 172 are defined in step 208 and the communicator module 174 is created or designated in step 210. The XSLT stylesheet 178 and the XML schema are identified in step 212, although this step might be skipped if the message broker is relied upon for data transformations. Finally, a bootstrapper is defined at step 214. A bootstrapper is a module whose sole function is to initiate the adapter 64 when it is needed by the application 42 and to bring down the adapter 64 when it is no longer needed. The bootstrapper can be part of the application program 42, or can exist independently from the application 42. Once the bootstrapper is defined, the process 200 is completed, and a ready-to-use adapter such as adapter 180 has been created.

Components of an Adapter

FIG. 8 shows a more detailed schematic representation of the request/reply/acknowledge initiator adapter 64 shown in FIG. 4. Just as was shown in FIG. 4, FIG. 8 shows adapter 64 communicating with the initiator business application 42 and the message transport layer 48. A bootstrapper 220 has been added to this FIG. 8 to highlight that the bootstrapper 220 is responsible for initiating and bringing down the adapter 64. The dotted line between the bootstrapper 220 and the initiator business application 42 indicates that the bootstrapper 220 acts in coordination with the needs of the application 42 to communicate over the message transport layer 48.

The adapter 64 contains two primary communications components, namely a request/reply initiator adapter 52 and a sender adapter 13a. Communication between the subcomponent adapters 52, 13a and the initiator application 42 is transacted through the communicator 174a, which is customized to work with the specific application 42 as described above.

Both of the subcomponent adapters 13a, 52 will have their own communicator element 174b and 174c to handle communications with their own subcomponents. For example, the sender component 13a has a communicator element 174b that handles communication between its own logic and the communicator 174a of the initiator adapter 64.

The request/reply initiator adapter 52 is itself made up of the combination of two subcomponents, namely its own sender adapter 13b and a receiver adapter 17. The request/reply adapter 52 also has its own communicator 174c, which is responsible for coordinating the actions of these two subcomponents 13b, 17, and for all communications between the communicator 17a of the initiator adapter 64 and these subcomponents 13b, 17. Finally, FIG. 8 shows that the subcomponent adapters 13b, 17 of the request/reply initiator adapter 52 also have their own communicators 174d, 174e.

The sender adapters 13a, 13b and the receiver adapter 17 contain all of the programming logic necessary to communicate via the message transport layer 48. Although this may lead to some duplication is programming logic as similar functions exist in subcomponents 13a and 13b, the simplicity of being able to define adapters as a nested combination of other adapters more than makes up for the additional storage requirement needed for the duplicated code.

The invention is not to be taken as limited to all of the details thereof as modifications and variations thereof may be made without departing from the spirit or scope of the invention. For instance, the above explanation described five different communication paradigms shown in FIGS. 1 through 5. In addition to these paradigms, it is clear that the present invention can be used in numerous other communication paradigms defined from the basic point-to-point and publish-and-subscribe paradigms. Furthermore, although the above description refers to XML schemas and XSLT stylesheets, it would be a simple matter to implement the present invention using other data handling protocols, such as by using Java code instead of XSLT stylesheets. In addition, although the above description speaks of instantiating a class, it would be possible to implement the above invention outside of the object-oriented programming model. Consequently, the invention should be limited only by the following claims.

What is claimed is:

1. An object-oriented programming object defining a communication paradigm between an initiator application and a respondent application over a middleware transport layer, the paradigm object comprising:
a) a plurality of predefined sub-paradigms chosen from a set comprising a point-to-point paradigm, a publish-and-subscribe paradigm, and a complex sub-paradigm, wherein the complex sub-paradigm is itself an object-oriented programming object containing a plurality of predefined sub-sub-paradigms, and further wherein the predefined sub-paradigms each contain logic sufficient to define a sub-paradigm adapter core; and
b) programming logic sufficient to create an initiator adapter core and a respondent adapter core, wherein the initiator and respondent adapter cores each contain sub-paradigm adapter cores from each of the predefined sub-paradigms contained in the paradigm object.

2. A method for creating a middleware adapter comprising the steps of:
a) instantiating a complex paradigm object, the paradigm object
i) defining a plurality of communications between an initiator application and at least one respondent application,
ii) containing a plurality of predefined sub-paradigms chosen from a set comprising a point-to-point paradigm, a publish-and-subscribe paradigm, and a complex sub-paradigm, wherein the complex sub-paradigm is itself a complex paradigm object containing a plurality of predefined sub-sub-paradigms, and further wherein the predefined sub-paradigms each contain logic sufficient to define a sub-paradigm adapter core, and
iii) containing logic sufficient to create an initiator adapter core and a respondent adapter core, wherein the initiator and respondent adapter cores each contain sub-paradigm adapter cores from each of the predefined sub-paradigms contained in the paradigm object;
b) choosing either the initiator application or one of the respondent applications as a chosen application;
c) requesting the adapter core for the chosen application from the instance of the paradigm object, wherein the adapter core is capable of handling all of the plurality of communications defined in the paradigm object for the chosen application; and
d) defining a communicator interface between the chosen application and the adapter.

3. The method of claim 2, further comprising the step of:
e) defining a data transformation stylesheet for handling data transformation between a data format used by the chosen application and a predefined canonical data format.

4. A method for automatically creating an adapter for use with a middleware message transport layer, the method comprising the steps of:
a) defining a communication paradigm, the communication paradigm having
i) an initiator application and at least one respondent application;
ii) a plurality of communications between the initiator application and the respondent applications, with at least one communication being sent from the initiator application to the respondent application, and at least one communication being sent from the respondent application to the initiator application;
b) using the communication paradigm to automatically create an adapter core for a chosen one of the applications, the adapter core having
i) at least one sender component for sending a communication over the message transport layer; and
ii) at least one receiver component for receiving a communication from the message transport layer; and
c) adding a communicator to the adapter core, the communicator being programmed to communicate data between the chosen one of the applications and the adapter core;
d) defining a transformation specification defining data transformations necessary to transform the data in a message between a data format used by the chosen application and a canonical data format.

5. The method of claim 4, wherein the transformation specification is an XSLT stylesheet.

6. The method of claim 5, further comprising the step of:
e) defining a data schema within the adapter to validate the structure and syntax of the data transmitted over the message transport layer.
